(19) United States
(12) Patent Application Publication
(10) Pub. No.: US 2026/0311143 A1
(43) Pub. Date: Oct. 8, 2026

(54) CONTENT POSTING

(71) Applicant: Bytedance Technology Ltd., Grand Cayman (KY)

(72) Inventors: Lingxuan Shen, Beijing (CN); Jialu Li, Beijing (CN); Zhenan Li, Beijing (CN)

(21) Appl. No.: 19/640,090

(22) Filed: Apr. 6, 2026

(30) Foreign Application Priority Data
Apr. 7, 2025 (WO) PCT/SG2025/050241

(51) Int. Cl. G06Q 10/40; G11B 27/031

(52) U.S. Cl. CPC G06Q 10/40; G11B 27/031

(57) ABSTRACT

Accoding to embodiments of this disclosure, a method, apparatus, device and storage medium for content posting is provided. The method includes: presenting, in response to a selection of an editing entry in an application, a first editing interface which presents a first historical media content of a set of historical media contents, the set of historical media contents being determined from a media content set associated with the application based on a temporal constraint associated with a current time; switching, in response to receiving a first switching operation in the first editing interface, the first editing interface to presenting a second historical media content of the set of historical media contents; and posting, in response to receiving a selection of a posting entry in the first editing interface, a first media content item corresponding to the second historical media content presented in the first editing interface.

### CROSS-REFERENCE

The present application claims priority to International Application No. PCT/SG2025/050241, filed on Apr. 07, 2025, entitled “METHOD, APPARATUS, DEVICE AND STORAGE MEDIUM FOR CONTENT POSTING”, the entirety of which is incorporated herein by reference.

### FIELD

Example embodiments of the present disclosure generally relate to the field of computers, and in particular, to content posting.

### BACKGROUND

With the development of computer technologies, various forms of electronic devices can greatly enrich people's daily life. For example, people may utilize electronic devices for content posting. How to improve the efficiency of content posting is a focus problem of attention.

### SUMMARY

In a first aspect of the present disclosure, a method for content posting is provided. The method includes: presenting, in response to a selection of an editing entry in an application, a first editing interface which presents first historical media content of a set of historical media content, the set of historical media content being determined from a media content set associated with the application based on a temporal constraint associated with a current time; causing, in response to receiving a first switching operation in the first editing interface, the first editing interface to present second historical media content of the set of historical media content; and posting, in response to receiving a selection of a posting entry in the first editing interface, a first media content item corresponding to the second historical media content presented in the first editing interface.

In a second aspect of the present disclosure, an apparatus for content posting is provided. The apparatus includes: a first presentation module configured to present, in response to a selection of an editing entry in an application, a first editing interface which presents first historical media content of a set of historical media content, the set of historical media content is determined from a media content set associated with the application based on a temporal constraint associated with a current time; a switching module configured to cause, in response to receiving a first switching operation in the first editing interface, the first editing interface to present second historical media content of the set of historical media content; and a first posting module configured to post, in response to receiving a selection of a posting entry in the first editing interface, a first media content item corresponding to the second historical media content presented in the first editing interface.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

In a fifth aspect of the present disclosure, a computer program product is provided. The computer program product includes computer-executable instructions that, when executed by a processor, implement the method of the first aspect of the present disclosure.

It should be understood that the content described in this summary section is not intended to limit key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIGS. 2A-2H illustrate schematic diagrams of interfaces according to some embodiments of the present disclosure;

FIG. 3 illustrates a flowchart of a content posting process according to some embodiments of the present disclosure;

FIG. 4 illustrates a schematic structural block diagram of an apparatus for content posting according to some embodiments of the present disclosure;

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although some embodiments of the present disclosure are shown in the accompanying drawings, it is to be understood that the present disclosure may be implemented in various forms, and should not be interpreted as limited to embodiments set forth herein. On the contrary, these embodiments are provided for a more thorough and complete understanding of the present disclosure. It is to be understood that the drawings and embodiments of the present disclosure are merely for example purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiments described in the same section/subsection and/or different section/subsection.

In the description of embodiments of the present disclosure, the term “comprising” and the like should be understood as openness, i.e., “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second” and the like may refer to different or identical objects. Other explicit and implicit definitions may also be included below.

Embodiments of the present disclosure may relate to data of a user, obtaining and/or usage of the data, and the like. These aspects all follow the corresponding laws and regulations and related regulations. In the embodiments of the present disclosure, all data collection, obtaining, handling, processing, forwarding, usage, etc. are conducted with the user’s knowledge and consent. Accordingly, when implementing the various embodiments of the present disclosure, types, usage scopes, usage scenarios, and the like of the data or information that may be involved should be informed to the users and obtain user authorization in an appropriate manner according to the relevant laws and regulations. A specific notification and/or authorization manner may vary according to actual situations and application scenarios, and the scope of the present disclosure is not limited in this respect.

The solutions in the present specification and the embodiments, if personal information processing is involved, may be processed on the premise of having a legality basis (for example, obtaining consent of a personal information subject, or being necessary for performing a contract, etc.), and may be processed only within a specified or agreed range. The user rejects personal information other than necessary information required for basic functions, and will not affect use of basic functions.

Embodiments of the present disclosure provides a solution for content posting. According to the solution, in response to a selection of an editing entry in an application, a first editing interface is presented, the first editing interface presents first historical media content of a set of historical media content, the set of historical media content is determined from a media content set associated with the application based on a temporal constraint associated with a current time; in response to receiving a first switching operation in the first editing interface, the first editing interface is switched to presenting second historical media content of the set of historical media content; and in response to receiving the selection of a posting entry in the first editing interface, a first media content item corresponding to the second historical media content presented in the first editing interface is posted.

In this way, the embodiments of the present disclosure can support the user being able to switch and view different items in the same historical media content group by performing the first switching operation in the first editing interface, and this dynamic switching function can effectively improve content delivery efficiency. In addition, the present disclosure may directly and conveniently post the first media content item corresponding to the currently presented second historical media content based on the posting entry in the first editing interface, without switching to other interfaces or performing additional steps, reducing cost of content posting and improving content posting efficiency.

### Example Environment

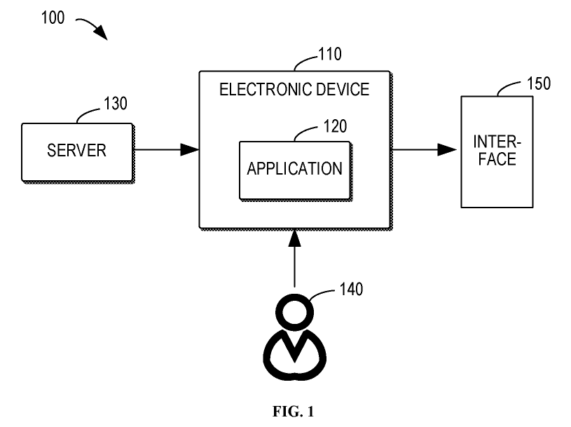

FIG. 1 illustrates a schematic diagram of an example environment 100 in which embodiments of the present disclosure may be implemented. As shown in FIG. 1, the example environment 100 may include an electronic device 110.

In this example environment 100, an application 120 is installed in the electronic device 110. A user 140 may interact with the application 120 via the electronic device 110 and/or its attachment device. The application 120 may be a media application, a social application, a game application, or any other suitable application.

In the environment 100 of FIG. 1, if the application 120 is in an active state, the application 120 may provide a presentation interface 150 for the user 140.

In some embodiments, the electronic device 110 communicates with a server 130 to provide services to the application 120. The electronic device 110 may be any type of a mobile terminal, a fixed terminal, or a portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be an independent physical server, a server cluster composed of a plurality of physical servers, or a distributed system, or may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 in the electronic device 110 that supports content posting.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus connection, a Wireless Fidelity connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for example purposes only and do not imply any limitation to the scope of the present disclosure.

Some example embodiments of the present disclosure will be described below with continued reference to the accompanying drawings.

### Example Processes

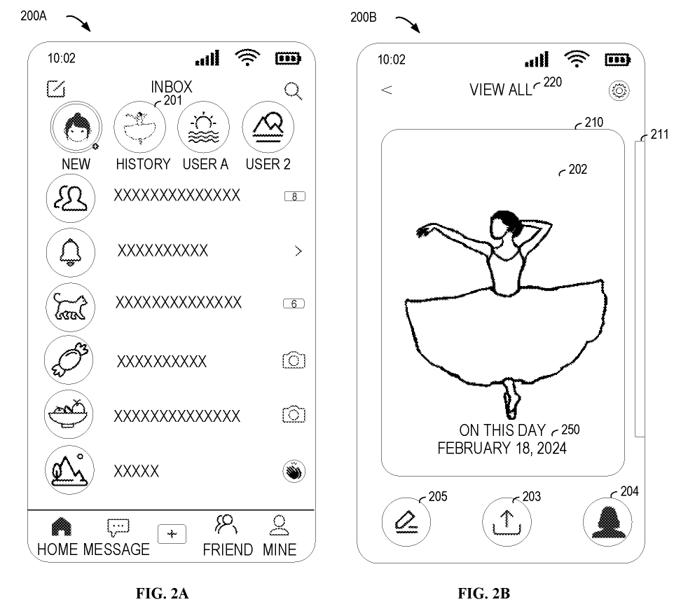

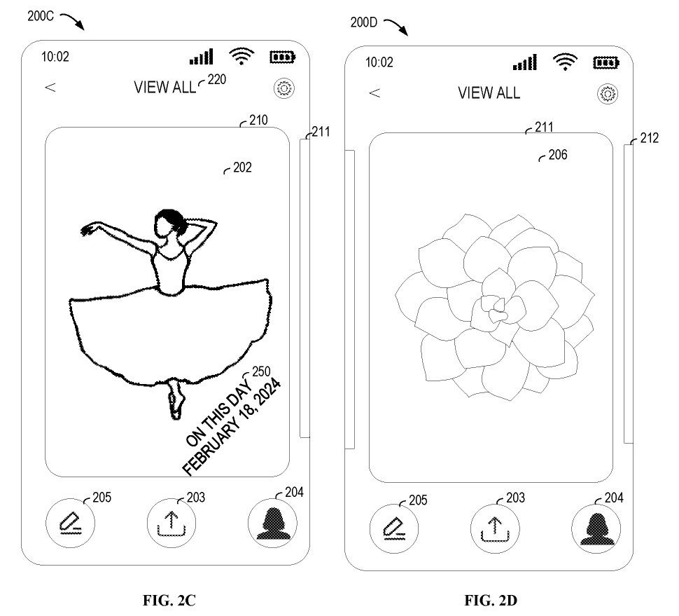

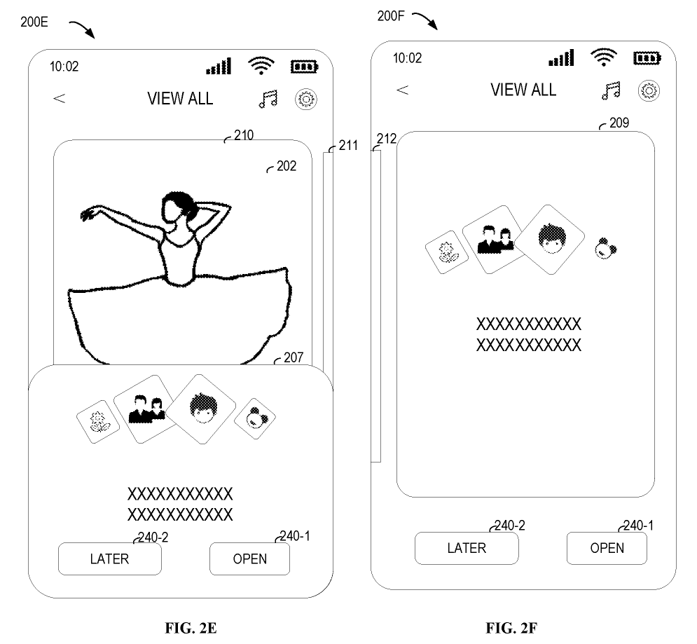

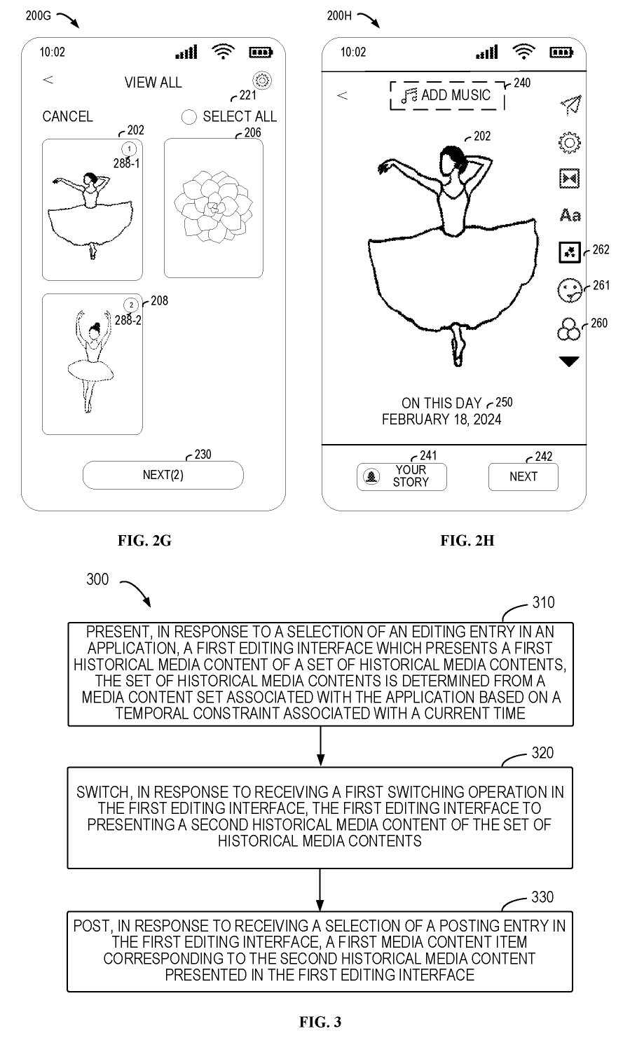

An example interaction process according to embodiments of the present disclosure will be described below with reference to FIGS. 2A-2H. FIGS. 2A-2H illustrate example interfaces 200A-200H in accordance with some embodiments of the present disclosure, the interfaces 200A-200H may be provided, for example, by a display device 110 shown in FIG. 1.

In some embodiments, the electronic device 110 may provide an editing entry in an application 120, the editing entry may be a functional entry that guides a user to view and/or edit a set of historical media content associated with the user.

In some embodiments, the set of historical media content may be any suitable type of content, for example, may be an image, a video, an audio, or the like, and details are not described herein again.

In some embodiments, the set of historical media content may be determined from a media content set associated with the application 120 based on a temporal constraint. The media content set may be a first media content set corresponding to a first content source and/or a second media content set corresponding to a second content source. The content source may represent an entity or location that generates, provides, or stores the media content set, where the first media content set and the second media content set correspond to different content sources. For example, the first content source may indicate historical media content posted by the user in the application 120, and the second content source may indicate historical media content locally stored on the electronic device 110 in which the application 120 is installed. The temporal constraint may indicate a time requirement corresponding to the set of historical media content selected from the media content set.

As an example, the set of historical media content may be historical media content that corresponds to the same date as the current date but in a different year from the current year, and is posted by the user 140 in the application 120.

In some implementations, the electronic device 110 may present the editing entry on any suitable interface supported by the application 120. As an example, the electronic device 110 may present the editing entry in a message viewing interface of the application 120. Taking FIG. 2A as an example, the electronic device 110 may present an interface 200A, where the interface 200A is a message viewing interface, and an editing entry 201 may be presented in the interface 200A. The message viewing interface may present a plurality of chat entries corresponding to the user 140 and other users, so as to support the user 140 to chat with other users by clicking a certain chat entry, that is, the electronic device may present a chat interface between the user 140 and other users in response to receiving a selection of the certain chat entry.

In some embodiments, the editing entry 201 may be presented at any suitable location on the interface. Taking FIG. 2A as an example, the electronic device 110 may present the editing entry in a strip-shaped region corresponding to top of the interface 200A (the strip-shaped region may also be referred to as a skylight). Furthermore, in addition to the entry 201, other controls (for example, a selection control corresponding to a chat entry of other users who are frequently contacted by the user) may also be presented in the strip-shaped region, and details are not described herein again.

In some embodiments, each control in the strip-shaped region may correspond to a predetermined visual element. The visual element may be any suitable element, for example, a visual element corresponding to a selection control corresponding to a chat entry of another user may be an avatar corresponding to the other user, and the like.

In some embodiments, the editing entry 201 may also present a predetermined visual element. As an example, the editing entry 201 may present an image associated with at least one piece of historical media content of a set of historical media content. The at least one piece of historical media content may be any suitable media content, for example, may be any historical media content selected randomly from the set of historical media content, or may be historical media content that is the first historical media content in a presentation order in the set of historical media content (that is, cover media content). It should be noted that, the presentation order herein represents an order in which the set of historical media content is presented in the first editing interface after clicking the editing entry 201. In some embodiments, the presentation order corresponding to the plurality of historical media content may be determined based on any suitable information such as interaction information and attribute information corresponding to the media content. The interaction information may include information corresponding to the media content such as a playback popularity, a number of likes, a number of comments, and a number of shares. The attribute information corresponding to the media content may be a posting time, a playback duration, a shooting time, a storage time, and the like. As an example, the electronic device 110 may set the historical media content with greater playback popularity to a more prior position in the presentation order.

As an example, the editing entry 201 may present a thumbnail corresponding to the image associated with the at least one piece of historical media content in the set of historical media content.

Taking FIG. 2B as an example, the electronic device 110 may present an interface 200B (the first editing interface) as shown in FIG. 2B in response to a selection of the editing entry 201 in the application 120.

Further, the electronic device 110 may sequentially present the set of historical media content in a predetermined presentation order in the interface 200B. Taking FIG. 2B as an example, the electronic device 110 may present, in the interface 200B, historical media content 202 (first historical media content) in the set of historical media content in response to a selection of the editing entry 201.

Taking FIG. 2B as an example, the electronic device 110 may further present, in the interface 200B, a media material associated with a temporal constraint, where the media material may be any suitable material, for example, may be a text material, an image material, a sticker material, and the like, and details are not described herein again. The media material may correspond to a first style. Taking FIG. 2B as an example, the electronic device 110 may present a media material 250 in the first style in the interface 200B.

Further, the electronic device 110 may update the media material 250 from the first style to a second style in response to receiving a switching operation for the media material. The switching operation may be any suitable operation, for example, may be an operation of clicking the media material 250, or may be an operation of clicking any other suitable position in the interface 200B. Taking FIG. 2C as an example, the user may click the media material 250 in the interface 200B, so that the electronic device 110 may present an interface 200C in response to receiving an adjustment operation on the media material 250, where the media material 250 is presented in the second style in the interface 200C.

In some embodiments, the electronic device 110 may present an editing control 205 in the interface 200B to support the user entering the editing interface corresponding to the currently presented historical media content 202 by clicking the editing control 205 to perform an editing operation on the historical media content 202, that is, the electronic device 110 may present the editing interface corresponding to the currently presented historical media content 202 in response to the control 205 being selected.

In some embodiments, the electronic device 110 may provide a plurality of posting entries corresponding to different distribution types in the editing interface 200B. The different distribution types may correspond to different posting paths, which may affect a presentation form of a media content item corresponding to the posted media content in the application 120. The presentation form may indicate a presentation duration, a visual range, a presentation location, and/or the like. The media content item may be an image, or may be a video, an animation, and the like, and details are not described herein again.

Taking FIG. 2B as an example, the electronic device 110 may present a posting entry 203 and a posting entry 204 in the editing interface 200B to support conveniently posting the media content item corresponding to the historical media content 202 currently presented in the editing interface 200B into the application 120. The posting entry 203 may support posting the media content item corresponding to the historical media content 202 currently presented in the editing interface 200B into a first presentation module on the application 120 in a first presentation form. The posting entry 204 may support posting the media content item corresponding to the historical media content 202 currently presented in the editing interface 200B into a second presentation module on the application 120 in a second presentation form. And the first presentation form and the second presentation form may correspond to at least one of different presentation durations, correspond to different visual ranges, and correspond to different presentation locations.

As an example, the electronic device 110 may post a media content item corresponding to the historical media content 202 to the application 120 in response to a selection of the posting entry 203, and support that presentation duration corresponding to the media content item corresponding to the historical media content 202 is permanently valid, and support that the media content item corresponding to the historical media content 202 is allowed to be viewed by all other users associated with the application 120.

As another example, the electronic device 110 may post the media content item corresponding to the historical media content 202 to the application 120 in response to a selection of the posting entry 204, and support that the presentation duration corresponding to the media content item corresponding to the historical media content 202 is valid in a predetermined duration (for example, within 24 hours), and support that the media content item corresponding to the historical media content 202 is viewed by other users associated with the application 120 and having a predetermined association relationship with the user (such as friends of the user 140).

In some embodiments, the electronic device 110 may switch the editing interface 200B to an editing interface 200D (the first editing interface) in response to receiving a first switching operation in the editing interface 200B, wherein the editing interface 200D may present historical media content 206, and the editing interface 200D may be an editing interface corresponding to the historical media content 206. The first switching operation may be any suitable operation, for example, may be a sliding operation, a clicking operation, or the like.

As an example, the user may switch the historical media content presented in the editing interface based on a left and right sliding operation, and the historical media content 202 is adjacent to the historical media content 206, and take a presentation order corresponding to the historical media content 202 being earlier than that of the historical media content 206 as an example for description. The electronic device 110 may present an interface 200D in response to receiving the left and right sliding operation of the user on the editing interface 200B, and the historical media content 206 may be presented in the interface 200D.

In some embodiments, the set of historical media content may be presented on the editing interface based on a predetermined form, for example, the electronic device 110 may present the set of historical media content on a set of card interfaces on the editing interface to allow the user to switch and browse different cards through a predetermined operation, where different cards are used to display different historical media content. The predetermined operation may be a sliding operation in a predetermined direction (such as horizontal and vertical, etc.).

Taking FIG. 2B as an example, the electronic device 110 may present a card interface 210 in the editing interface 200B, where the card interface 210 is used to present the historical media content 202.

To facilitate reminding the user that there are other historical media content following the historical media content 202 available for display, the electronic device 110 may present a portion of a card interface 211 in the editing interface 200B, where the card interface 211 is used to present the historical media content 206, and a portion of the card interface 211 may be presented on the right side of the card interface 210.

Taking FIG. 2D as an example, the electronic device 110 may present, in response to receiving the user left sliding operation on the interface 200B, an interface 200D as shown in FIG. 2D, in which case the card interface 211 is presented at a center position of the editing interface 200D, and a portion of the card interface 210 is presented on the left side of the card interface 211, and a portion of a card interface 212 is presented on the right side of the card interface 211, so as to remind the user that other historical media content preceding and following the historical media content 206 are available for display.

Further, the electronic device 110 may post a first media content item corresponding to the historical media content 206 in response to selection of the posting entry 203 or the posting entry 204 in the editing interface 200D.

As an example, the electronic device 110 may post the first media content item corresponding to the historical media content 206 to the application 120 in response to a selection of the posting entry 203 in the editing interface 200D, and support that the presentation duration corresponding to the first media content item corresponding to the historical media content 206 is permanently valid, and support it being viewed by all other users associated with the application 120.

As another example, the electronic device 110 may post the first media content item corresponding to the historical media content 206 to the application 120 in response to a selection of the posting entry 204, and support that the presentation duration corresponding to the first media content item corresponding to the historical media content 206 is valid in a predetermined duration (for example, within 24 hours), and support it being viewed by other users associated with the application 120 and users with a predetermined association relationship with the user (such as friends of the user 140).

In order to protect security of privacy data of the user, the electronic device 110 may include, in response to receiving an authorization determination from the user for a predetermined content source, the historical media content corresponding to the predetermined content source in the set of historical media content to be presented in an editing interface of the application 120. The predetermined content source may be any suitable content source, for example, may be a content source independent of the application 120. As an example, the predetermined content source may indicate historical media content locally stored on the electronic device 110 in which the application 120 is installed, that is, the electronic device 110 may set that, when no authorization determination of the user is received, the presented set of historical media content may not include historical media content locally stored on the electronic device 110 in which the application 120 is installed, and may only include historical media content posted in the application 120.

To improve richness of presentable historical media content to provide more selections to the user, the electronic device 110 may present an authorization control associated with a predetermined content source to support the user selecting whether to authorize presentation of historical media content corresponding to the predetermined content source on the editing interface.

Further, the user may confirm the authorization to present the historical media content corresponding to the predetermined content source on the editing interface by clicking the authorization control. At this time, the electronic device 110 may update the set of historical media content based on the predetermined content source in response to the authorization control being triggered. As an example, the electronic device 110 may select, from a plurality of historical media content corresponding to the predetermined content source, historical media content meeting a temporal constraint, and add the historical media contents to the set of historical media content.

In some embodiments, the electronic device 110 may present the authorization control while presenting the most prior historical media content 202 in a presentation order in the set of historical media content in response to the editing entry 201 being triggered.

Taking FIG. 2E as an example, the electronic device 110 may present an interface 200E as shown in FIG. 2E in response to receiving a selection of the editing entry 201, where a portion of the historical media content 202 may be presented in an interface 200E. The electronic device 110 may present a window 207 in the interface 200E, where an authorization control 240-1 and an unauthorized control 240-2 may be presented in the window 207. In some embodiments, the electronic device 110 may add the historical media content locally stored on the electronic device 110 to a set of historical media content in response to receiving a trigger for the authorization control 240-1, such as clicking on the authorization control 240-1. In some other embodiments, the electronic device 110 may determine not to add the historical media content locally stored on the electronic device 110 to the set of historical media content in response to receiving a selection of the unauthorized control 240-2, that is, the set of historical media content also includes only historical media content posted on the application 120.

Taking FIG. 2F as an example, if the last historical media content 208 in the presentation order is presented in the set of historical media content at this time in the editing interface, where the last historical media content 208 in the presentation order may be presented in a card interface 212, it indicates that no other historical media content subsequent to the currently presented historical media content 208 could be presented, at this time, the electronic device 110 may receive a second switching operation in the editing interface, and the second switching operation may be any appropriate operation, such as a left-sliding operation. Further, the electronic device 110 may present, in response to the first editing interface currently presenting the last historical media content in the set of historical media content, a prompt panel 209 based on the second switching operation. The electronic device 110 may present the authorization control 240-1 and the unauthorized control 240-2 in the prompt panel 209. In some embodiments, the electronic device 110 may add the historical media content locally stored on the electronic device 110 to the set of historical media content in response to receiving the selection of the authorization control 240-1. In some other embodiments, the electronic device 110 may determine not to add the historical media content locally stored on the electronic device 110 to the set of historical media content in response to receiving the selection of the unauthorized control 240-2, that is, the set of historical media content also includes only historical media content posted on the application 120.

In some embodiments, the present disclosure may support editing and posting of a plurality of historical media content in addition to editing and posting of a single piece of historical media content.

Returning to FIG. 2B, the electronic device 110 may present a viewing control 220 in the editing interface 200B. Further, the electronic device 110 may present an interface 200G as shown in FIG. 2G in response to a selection of the viewing control 220 in the editing interface 200B, where the set of historical media content (including the historical media content 202, the historical media content 206, and the historical media content 208) may be presented in the interface 200G.

Further, the user may select a plurality of historical media content in the set of historical media content based on a predetermined operation, so that the electronic device 110 may receive a selection of the plurality of historical media content in the set of historical media content. The predetermined operation may be any suitable operation, for example, a clicking operation, a sliding operation, or the like.

As an example, the electronic device 110 may present a selection control 221 corresponding to “select all” in the interface 200G to support the user to conveniently select the set of historical media content presented in the interface 200G. Further, the electronic device 110 may determine that all media content in the set of historical media content is selected in response to the selection control 221 being selected.

As another example, for each historical media content in the set of historical media content, the electronic device 110 may present a selection control corresponding to this historical media content in the interface 200G. Further, the electronic device 110 may determine that the historical media content 208 and the historical media content 202 are selected in response to a selection control corresponding to the historical media content 208 and a selection control corresponding to the historical media content 202 being clicked.

In some embodiments, the electronic device 110 may present a control 230 in the interface 200G. The control 230 may present a first indication element to indicate a quantity corresponding to the selected plurality of historical media content. For example, the electronic device 110 may present an indication element corresponding to “(2)” in the control 230 to indicate that there are 2 selected historical media content in the interface 200G.

In some embodiments, for the selected historical media content, the electronic device 110 may also present, in the interface 200G, a second indication element to indicate that this historical media content is selected. In addition, the second indication element may indicate an order in which the historical media content is selected in addition to representing the corresponding historical media content being selected. Taking FIG. 2G as an example, the electronic device 110 may present an indication element 288-1 in a region related to the historical media content 202 to indicate that the historical media content 202 is selected, and the historical media content 202 is the first historical media content to be selected, and the electronic device 110 may present an indication element 288-2 in a region related to the historical media content 208 to indicate that the historical media content 208 is selected, and the historical media content 208 is the second historical media content to be selected.

Further, the electronic device 110 may present, in response to a selection of the control 230 (for example, the user may click the control 230), an interface 200H as shown in FIG. 2H, where the interface 200H may be an editing interface (a second editing interface) corresponding to the plurality of historical media content.

In some embodiments, the electronic device 110 may present a set of editing controls in the interface 200H to support the user editing the plurality of historical media content.

As an example, the electronic device 110 may present an audio control 240 in the interface 200H to indicate that the user may set corresponding audio for the plurality of historical media content. In some embodiments, the user may click the audio control 240 to cause the electronic device 110 to be able to receive a selection of the audio control 240, thereby presenting a set of candidate audio. Further, in response to an audio is selected from the set of candidate audio, the electronic device 110 may add music for the second media content item corresponding to the plurality of historical media content based on the selected audio.

In some embodiments, the second media content item may be video content corresponding to the plurality of historical media content or an image set corresponding to the plurality of historical media content.

Taking FIG. 2H as an example, the electronic device 110 may provide a plurality of posting entries in the interface 200H, the plurality of posting entries may correspond to different types of the second media content item.

As an example, the electronic device 110 may generate a first image set based on the historical media content 202 and the historical media content 208 in response to a selection of a posting entry 241. Further, the electronic device 110 may post the image set.

Taking FIG. 2H as an example, the electronic device 110 may generate first video content based on the historical media content 202 and the historical media content 208 in response to a selection of a posting entry 242. Further, the electronic device 110 may post the first video content.

In some embodiments, the electronic device 110 may further present, in the interface 200H, a filter control 260, a sticker control 261, a special effect control 262, and the like, to support the user to select a filter, a sticker, and/or a special effect for the historical media content 202 and the historical media content 208, and details are not described herein again.

In this way, the embodiments of the present disclosure can support the user being able to switch and view different items in the same historical media content group by performing the first switching operation in the first editing interface, and this dynamic switching function can effectively improve the content delivery efficiency. In addition, the present disclosure may directly and conveniently post the first media content item corresponding to the currently presented second historical media content based on the posting entry in the first editing interface, without switching to other interfaces or performing additional steps, reducing cost of content posting and improving the efficiency of content posting.

### Example Processes

FIG. 3 illustrates a flowchart of a content posting process 300 according to some embodiments of the present disclosure. Process 300 may be implemented at the electronic device 110. The process 300 is described below with reference to FIG. 1.

At block 310, the electronic device 110 presents, in response to a selection of an editing entry in an application, a first editing interface which presents first historical media content of a set of historical media content, the set of historical media content being determined from a media content set associated with the application based on a temporal constraint associated with a current time.

At block 320, the electronic device 110 switches, in response to receiving a first switching operation in the first editing interface, the first editing interface to presenting second historical media content of the set of historical media content.

At block 330, the electronic device 110 posts, in response to receiving a selection of a posting entry in the first editing interface, a first media content item corresponding to the second historical media content presented in the first editing interface.

In this way, the embodiments of the present disclosure can support the user being able to switch and view different items in the same historical media content group by performing the first switching operation in the first editing interface, and this dynamic switching function can effectively improve the content delivery efficiency. In addition, the present disclosure may directly and conveniently post the first media content item corresponding to the currently presented the second historical media content based on the posting entry in the first editing interface, without switching to other interfaces or performing additional steps, reducing the cost of content posting and improving the efficiency of content posting.

In some embodiments, the media content set includes at least one of the following: a first media content set corresponding to a first content source, the first content source indicating historical media content posted by the current user in the application; a second media content set corresponding to a second content source, the second content source indicating historical media content locally stored on an electronic device in which the application is installed.

In this way, embodiments of the present disclosure can ensure that the media content set presented in the editing interface includes the media content from different content sources, which enriches the diversity of the presented media content and improves the information delivery efficiency.

In some embodiments, the process 300 further includes: presenting an authorization control associated with a predetermined content source; and updating, based on triggering of the authorization control, the set of historical media content based on the predetermined content source.

In this way, embodiments of the present disclosure may facilitate the user to manage authorization of the content source by presenting the authorization control associated with the predetermined content source, thereby effectively improving authorization management efficiency.

In some embodiments, presenting the authorization control associated with the predetermined content source includes: receiving a second switching operation in the first editing interface; and switching, in response to the first editing interface currently presenting last historical media content in the set of historical media content, based on the second switching operation, the first editing interface to presenting the authorization control.

In this way, embodiments of the present disclosure can dynamically manage the content source by presenting the authorization control at an appropriate timing, thereby improving authorization management efficiency.

In some embodiments, the first editing interface provides a plurality of posting entries corresponding to different distribution types.

In this way, embodiments of the present disclosure may support posting edited media content to different distribution channels, such diversified distribution channels may enhance coverage and visibility of the content.

In some embodiments, the process 300 further includes: in response to a selection of a viewing control in the first editing interface, presenting a set of historical media content; presenting, in response to a selection of a plurality of historical media content in the set of historical media content, a second editing interface corresponding to the selected plurality of historical media content; and posting a second media content item corresponding to the selected plurality of historical media content.

In this way, embodiments of the present disclosure may enable the user to select a plurality of content in a set of historical media content for editing and posting related content items, thereby effectively improving efficiency of editing and posting. In addition, after editing is completed, the second media content item corresponding to the selected plurality of historical media content can be directly posted, the posting process is simplified, and the content posting efficiency is improved.

In some embodiments, the second media content item includes: video content corresponding to the plurality of historical media content; or an image set corresponding to the plurality of historical media content.

In this way, embodiments of the present disclosure can integrate a plurality of historical media content into a video set or an image set, and compared with a single media content, embodiments of the present disclosure can provide more visual information, thereby effectively improving the information delivery efficiency.

In some embodiments, the process 300 further includes: in the first editing interface, presenting the media material associated with the temporal constraint, the media material corresponding to a first style; and updating, in response to receiving an adjustment operation on the media material, the media element from the first style to the second style.

In this way, embodiments of the present disclosure may present the media material based on the temporal constraint, and allow the user to adjust the style of the materials, and help to improve adaptability and editing flexibility of the content.

In some embodiments, the editing entry presents an image associated with at least one of the set of historical media content.

In this way, embodiments of the present disclosure can effectively ensure that the user can intuitively see an image associated with the historical media content by displaying the image associated with the historical media content at the editing entry, thereby improving the content delivery efficiency.

In some embodiments, the process 300 further includes providing the editing entry in a message viewing interface of the application.

In this way, embodiments of the present disclosure can enable the user to directly enter an editing mode from the message viewing interface, without searching for additional editing buttons or menus, effectively simplifying the editing process and improving the editing efficiency.

### Example Apparatuses and Devices

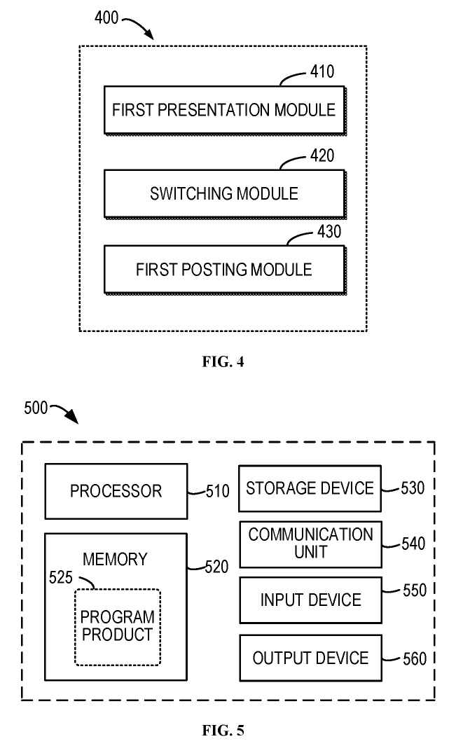

Embodiments of the present disclosure also provide a corresponding apparatus for implementing the above methods or processes. FIG. 4 illustrates a schematic structural block diagram of an apparatus 400 for content posting according to some embodiments of the present disclosure. The apparatus 400 may be implemented as the electronic device 110 or included in the electronic device 110 as discussed above. The various modules/components in the apparatus 400 may be implemented by hardware, software, firmware, or any combination thereof.

As shown in FIG. 4, the apparatus 400 includes a first presenting module 410 configured to present, in response to a selection of an editing entry in an application, a first editing interface which presents first historical media content of a set of historical media content, the set of historical media content is determined from a media content set associated with the application based on a temporal constraint associated with a current time; a switching module 420 configured to switch, in response to receiving a first switching operation in the first editing interface, the first editing interface to presenting second historical media content of the set of historical media content; and a posting module 430 configured to post, in response to receiving a selection of a posting entry in the first editing interface, a first media content item corresponding to the second historical media content presented in the first editing interface.

In some embodiments, the media content set includes at least one of the following: a first media content set corresponding to a first content source, the first content source indicating historical media content posted by a current user in the application; a second media content set corresponding to a second content source, the second content source indicating historical media content locally stored on an electronic device in which the application is installed.

In some embodiments, the apparatus 400 further includes a second presenting module configured to present an authorization control associated with a predetermined content source; and a first updating module configured to update, based on triggering of the authorization control, the set of historical media content based on the predetermined content source.

In some embodiments, the second presenting module is further configured to: receive a second switching operation in the first editing interface; and switch, in response to the first editing interface currently presenting last historical media content in the set of historical media content, based on the second switching operation, the first editing interface to presenting the authorization control.

In some embodiments, the first editing interface provides a plurality of posting entries corresponding to different distribution types.

In some embodiments, the apparatus 400 further includes a third presenting module configured to: in response to a selection of a viewing control in the first editing interface, present the set of historical media content; a fourth presenting module configured to present, in response to a selection of a plurality of historical media content in the set of historical media content, a second editing interface corresponding to the selected plurality of historical media content; and a second posting module configured to post a second media content item corresponding to the selected plurality of historical media content.

In some embodiments, the second media content item includes: video content corresponding to the plurality of historical media content; or an image set corresponding to the plurality of historical media content.

In some embodiments, the apparatus 400 further includes a fifth presenting module configured to: present, in the first editing interface, a media material associated with the temporal constraint, the media material corresponding to the first style; and a second updating module configured to, in response to receiving an adjustment operation on the media material, update the media element from the first style to a second style.

In some embodiments, the editing entry presents an image associated with at least one of the set of historical media content.

In some embodiments, the apparatus 400 further includes a providing module configured to provide the editing entry in a message viewing interface of the application.

Units included in the apparatus 400 may be implemented in various manners, including software, hardware, firmware, or any combination thereof. In some embodiments, one or more units may be implemented using software and/or firmware, such as machine-executable instructions stored on a storage medium. In addition to machine-executable instructions or as an alternative to machine-executable instructions, some or all of the elements in the apparatus 400 may be implemented, at least in part, by one or more hardware logic components. By way of example and rather than limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely for example and should not constitute any limitation on the functionality and scope of the embodiments described herein. The electronic device 500 shown in FIG. 5 may be configured to implement the electronic device 110 shown in FIG. 1.

As shown in FIG. 5, an electronic device 500 is in a form of a general-purpose electronic device. Components of the electronic device 500 may include, but are not limited to, one or more processors or processing units 510, memories 520, storage devices 530, one or more communication units 540, one or more input devices 550, and one or more output devices 560. The processor 510 may be an actual or virtual processor and capable of performing various processes according to programs stored in the memory 520. In a multiprocessor system, a plurality of processors performs computer-executable instructions in parallel to improve parallel processing capabilities of the electronic device 500.

Electronic device 500 typically includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. Storage device 530 may be a removable or non-removable medium and may include a machine-readable medium, such as a flash drive, magnetic disk, or any other medium, which may be capable of storing information and/or data (for example, training data for training) and may be accessed within the electronic device 500.

The electronic device 500 may further include additional removable/non-removable, volatile/non-volatile storage media. Although not shown in FIG. 5, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 520 may include a computer program product 525 having one or more program modules configured to perform various methods or acts of various embodiments of the present disclosure.

The communication unit 540 is configured to communicate with other electronic devices through a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external devices such as storage devices, display devices, etc. , communicate with one or more devices that enable a user to interact with the electronic device 500, or communicate with any device (e.g., a network card, a modem, etc. ) that enables the electronic device 500 to communicate with one or more other electronic devices. Such communication may be performed via an input/output (I/O) interface (not shown).

According to example implementations of the present disclosure, a computer-readable storage medium having computer executable instructions stored thereon is provided, where the computer executable instructions are executed by a processor to implement the method described above. According to example implementations of the present disclosure, a computer program product is further provided, the computer program product being tangibly stored on a non-transitory computer-readable medium and including computer executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowcharts and/or block diagrams, and combinations of blocks in the flowcharts and/or block diagrams, may be implemented by computer-readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce apparatuses to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagrams.

The computer-readable program instructions may be loaded onto a computer, other programmable data processing apparatuses, or other devices, such that a series of operational steps are performed on a computer, other programmable data processing apparatuses, or other devices to produce a computer-implemented process, thereby enabling the instructions executed on a computer, other programmable data processing apparatuses, or other devices to implement the functions/acts specified in the flowcharts and/or block diagrams block or blocks.

The flowcharts and block diagrams in the drawings show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in a reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, and the above descriptions are, for example, not exhaustive, and are not limited to the implementations disclosed. Many modifications and variations without departing from the scope and spirit of the various implementations illustrated will be apparent to those of ordinary skill in the art. Selection of the terms used herein is intended to best explain the principles of the implementations, practical applications, or improvements to techniques in the marketplace, or to enable others of ordinary skill in the art to understand the various implementations disclosed herein.

What is claimed is:

1. A method for content posting, comprising:
presenting, in response to a selection of an editing entry in an application, a first editing interface which presents first historical media content of a set of historical media content, the set of historical media content being determined from a media content set associated with the application based on a temporal constraint associated with a current time;
causing, in response to receiving a first switching operation in the first editing interface, the first editing interface to present second historical media content of the set of historical media content; and
posting, in response to receiving a selection of a posting entry in the first editing interface, a first media content item corresponding to the second historical media content presented in the first editing interface.

2. The method of claim 1, wherein the media content set comprises at least one of the following:
a first media content set corresponding to a first content source, the first content source indicating historical media content posted by a current user in the application; and
a second media content set corresponding to a second content source, the second content source indicating historical media content locally stored on an electronic device in which the application is installed.

3. The method of claim 1, further comprising:
presenting an authorization control associated with a predetermined content source; and
updating, in response to triggering of the authorization control, the set of historical media content based on the predetermined content source.

4. The method of claim 3, wherein presenting the authorization control associated with the predetermined content source comprises:
receiving a second switching operation in the first editing interface; and
causing, in response to the first editing interface currently presenting the last historical media content in the set of historical media content, based on the second switching operation, the first editing interface to present the authorization control.

5. The method of claim 1, wherein the first editing interface provides a plurality of posting entries corresponding to different distribution types.

6. The method of claim 1, further comprising:
presenting the set of historical media content in response to a selection of a viewing control in the first editing interface;
presenting, in response to a selection of a plurality of historical media content in the set of historical media content, a second editing interface corresponding to the selected plurality of historical media content; and
posting a second media content item corresponding to the selected plurality of historical media content.

7. The method of claim 6, wherein the second media content item comprises:
video content corresponding to the plurality of historical media content; or
an image set corresponding to the plurality of historical media content.

8. The method of claim 1, further comprising:
presenting, in the first editing interface, a media material associated with the temporal constraint, the media material corresponding to a first style; and
updating, in response to receiving an adjustment operation on the media material, a media element from the first style to a second style.

9. The method of claim 1, wherein the editing entry presents an image associated with at least one of the set of historical media content.

10. The method of claim 1, further comprising:
providing the editing entry in a message viewing interface of the application.

11. An electronic device, comprising:
at least one processor; and
at least one memory coupled to the at least one processor and storing instructions for execution by the at least one processor, wherein the instructions, when executed by the at least one processor, cause the electronic device to perform acts comrising:
presenting, in response to a selection of an editing entry in an application, a first editing interface which presents first historical media content of a set of historical media content, the set of historical media content being determined from a media content set associated with the application based on a temporal constraint associated with a current time;
causing, in response to receiving a first switching operation in the first editing interface, the first editing interface to present second historical media content of the set of historical media content; and
posting, in response to receiving a selection of a posting entry in the first editing interface, a first media content item corresponding to the second historical media content presented in the first editing interface.

12. The electronic device of claim 11, wherein the media content set comprises at least one of the following:
a first media content set corresponding to a first content source, the first content source indicating historical media content posted by a current user in the application; and
a second media content set corresponding to a second content source, the second content source indicating historical media content locally stored on an electronic device in which the application is installed.

13. The electronic device of claim 11, wherein the acts further comprise:
presenting an authorization control associated with a predetermined content source; and
updating, in response to triggering of the authorization control, the set of historical media content based on the predetermined content source.

14. The electronic device of claim 13, wherein presenting the authorization control associated with the predetermined content source comprises:
receiving a second switching operation in the first editing interface; and
causing, in response to the first editing interface currently presenting the last historical media content in the set of historical media content, based on the second switching operation, the first editing interface to present the authorization control.

15. The electronic device of claim 11, wherein the first editing interface provides a plurality of posting entries corresponding to different distribution types.

16. The electronic device of claim 11, wherein the acts further comprise:
presenting the set of historical media content in response to a selection of a viewing control in the first editing interface;
presenting, in response to a selection of a plurality of historical media content in the set of historical media content, a second editing interface corresponding to the selected plurality of historical media content; and
posting a second media content item corresponding to the selected plurality of historical media content.

17. The electronic device of claim 16, wherein the second media content item comprises:
a video content corresponding to the plurality of historical media content; or
an image set corresponding to the plurality of historical media content.

18. The electronic device of claim 11, wherein the acts further comprise:
presenting, in the first editing interface, a media material associated with the temporal constraint, the media material corresponding to a first style; and
updating, in response to receiving an adjustment operation on the media material, a media element from the first style to a second style.

19. The electronic device of claim 11, wherein the editing entry presents an image associated with at least one of the set of historical media content.

20. A non-transitory computer-readable storage medium having a computer program stored thereon, the computer program being executed by a processor to perform acts comprising:
presenting, in response to a selection of an editing entry in an application, a first editing interface which presents first historical media content of a set of historical media content, the set of historical media content being determined from a media content set associated with the application based on a temporal constraint associated with a current time;
causing, in response to receiving a first switching operation in the first editing interface, the first editing interface to present second historical media content of the set of historical media content; and
posting, in response to receiving a selection of a posting entry in the first editing interface, a first media content item corresponding to the second historical media content presented in the first editing interface.
